(19) United States
(12) Patent Application Publication
(10) Pub. No.: US 2019/0130427 A1
(43) Pub. Date: May 2, 2019

(54) CANDIDATE SITE EVALUATION SYSTEM AND CANDIDATE SITE EVALUATION METHOD

(71) Applicant: Panasonic Intellectual Property Management Co., Ltd., Osaka (JP)

(72) Inventors: Takahiro SUGIMOTO, Tokyo (JP); Takashi TAJIMA, Tokyo (JP); Masataka EJIMA, Chiba (JP)

(21) Appl. No.: 16/167,627

(22) Filed: Oct. 23, 2018

(30) Foreign Application Priority Data
Oct. 31, 2017 (JP) 2017-210925

(51) Int. Cl. G06Q 30/02; G06Q 10/06; G06F 17/30

(52) U.S. Cl. CPC G06Q 30/0205; G06F 17/30241; G06Q 10/067

(57) ABSTRACT

A candidate site evaluation system includes: an evaluator that evaluates suitability of a candidate site in a target area based on a candidate site evaluation model and a second map, the candidate site evaluation model being obtained as a result of machine learning using a first map that shows any area and position information indicating locations of one or more existing facilities of a predetermined business type in the any area and being for evaluating the candidate site for opening a facility of the predetermined business type, the second map showing the target area including the candidate site to be evaluated; and an output unit that outputs a result of the evaluation.

### CROSS REFERENCE TO RELATED APPLICATION

This application claims the benefit of priority of Japanese Patent Application Number 2017-210925 filed on Oct. 31, 2017, the entire content of which is hereby incorporated by reference.

### BACKGROUND

### 1. Technical Field

The present disclosure relates to a candidate site evaluation system and a candidate site evaluation method that evaluate candidate sites for opening a facility.

### 2. Description of the Related Art

A technique for evaluating candidate sites in an extensive area for opening a shop has been disclosed (for instance, Japanese Unexamined Patent Application Publication No. 2008-65607 and Japanese Patent No. 5785973). The method disclosed in Japanese Unexamined Patent Application Publication No. 2008-65607 constructs a model for evaluating a candidate site based on survey data such as the record and statistical data of stores opened in the past, and evaluates the candidate site. In addition, the method disclosed in Japanese Patent No. 5785973 evaluates a candidate site using a guide line connecting a district of residence and a competing store and the number of customers of the competing store.

### SUMMARY

However, first of all, information on the record of stores opened in the past and the number of customers of a competing store is difficult to obtain, and thus there is a problem that it is difficult to evaluate a candidate site for opening a facility by the above-mentioned technique in related art.

Thus, the present disclosure has been made to solve the above-mentioned problem, and it is an object to provide a candidate site evaluation system capable of evaluating a candidate site easily.

A candidate site evaluation system according to an aspect of the present disclosure includes: a candidate site evaluation system includes: an evaluator that evaluates suitability of a candidate site in a target area based on a candidate site evaluation model and a second map, the candidate site evaluation model being obtained as a result of machine learning using a first map that shows any area and position information indicating locations of one or more existing facilities of a predetermined business type in the any area and being for evaluating the candidate site for opening a facility of the predetermined business type, the second map showing the target area including the candidate site to be evaluated; and an output unit that outputs a result of the evaluation.

It should be noted that general or specific aspects may be implemented as a system, a device, a method, a storage medium, a computer program, or any selective combination thereof.

With the candidate site evaluation system according to the present disclosure, a candidate site can be easily evaluated.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a configuration diagram illustrating an example of a candidate site evaluation system according to an embodiment;

FIG. 2 is a table illustrating an example of position information;

FIG. 3 is a flowchart illustrating an example of the operation of the candidate site evaluation system according to the embodiment;

FIG. 4 is a map illustrating an example of a first map;

FIG. 5 is a map illustrating an example of a third map;

FIG. 6 is a map illustrating an example of a second map;

FIG. 7 is a map illustrating an example of an evaluation result;

FIG. 8 is a map illustrating an example of information included in the first map;

FIG. 9 is a map illustrating another example of information included in the first map;

FIG. 10 is a chart illustrating another example of an evaluation result;

FIG. 11 is a map illustrating another example of an evaluation result; and

FIG. 12 is a map illustrating another example of an evaluation result.

### DETAILED DESCRIPTION OF THE EMBODIMENTS

A candidate site evaluation system of the present disclosure includes: an evaluator that evaluates suitability of a candidate site in a target area based on a candidate site evaluation model and a second map, the candidate site evaluation model being obtained as a result of machine learning using a first map that shows any area and position information indicating locations of one or more existing facilities of a predetermined business type in the any area and being for evaluating the candidate site for opening a facility of the predetermined business type, the second map showing the target area including the candidate site to be evaluated; and an output unit that outputs a result of the evaluation.

The first map showing any area is, for instance, a map of a certain area drawn on a plane with a reduced scale. Such a map has been widely distributed, and thus easily available. The position information indicating the positions of existing facilities of a predetermined business type is also easily available by searching using the Internet or the like. Since the easily available information is used in machine learning, a candidate site for opening a facility can be easily evaluated.

The candidate site evaluation system may further include a generator that generates the candidate site evaluation model.

According to this, the first map and the position information are available with a low cost. Thus, a candidate site evaluation model can be generated with a low cost, and eventually, a candidate site evaluation system can be implemented with a low cost.

Also, the position information may be shown on a third map for the any area.

According to this, machine learning is performed using paired images of the first map in which the positions of existing facilities are not shown in any area and the third map in which the positions of existing facilities are shown in the any area. Thus, the machine learning can be efficiently performed by comparing the maps.

In addition, the first map and the second map may include geographic information obtained from a Geographic Information System (GIS).

According to this, the machine learning is performed using geographic information on land, facility, and road obtained from GIS, for instance. Thus, the information used for the machine learning is increased, the accuracy of the machine learning is increased, and the accuracy of evaluation of a candidate site can be increased.

In addition, the first map and the second map may include information on at least one of an amount of traffic, a congestion degree, a road classification, an altitude, a business type of facility, a facility name, and a land classification.

According to this, the machine learning is performed in consideration of factors to prevent customers from coming to a facility and factors to attract customers to a facility. Thus the accuracy of evaluation of a candidate site can be increased.

In addition, the output unit may output a map as the evaluation result, the map showing a candidate site having suitability at a certain level or higher in the target area.

According to this, excellent candidate sites become visually quite obvious.

In addition, the output unit may output a heat map as the evaluation result, the heat map showing suitability of each of the locations in the target area.

According to this, promising locations can be comprehensively recognized as the candidate sites.

In addition, the output unit may output suitability of one location in the target area as the evaluation result.

According to this, it is possible to specify a certain specific location and recognize the suitability of a candidate site at the location.

In addition, the one or more existing facilities may include a facility which existed in past but does not exist at present in the any area.

According to this, locations not suitable for a candidate site can be learned by the machine learning, thus the accuracy of evaluation of a candidate site can be increased.

The candidate site evaluation method of the present disclosure includes: generating a candidate site evaluation model which is obtained as a result of machine learning using a first map that shows any area and position information indicating locations of one or more existing facilities of a predetermined business type in the any area, and which is for evaluating a candidate site for opening a facility of the predetermined business type; evaluating suitability of the candidate site in a target area based on a second map and the candidate site evaluation model, the second map showing the target area including the candidate site to be evaluated; and outputting a result of the evaluating.

According to this, it is possible to provide a candidate site evaluation method capable of evaluating a candidate site easily.

Hereinafter, an embodiment will be specifically described with reference to the drawings.

It should be noted that each of the embodiments described below is a general or specific example. The numerical values, shapes, components, arrangement positions and topologies of the components, steps, and order of the steps that are depicted in the following embodiments are just examples, and are not intended to limit the scope of the present disclosure. Those components in the following embodiments, which are not stated in the independent claim that defines the most generic concept are each described as an arbitrary component.

### Embodiment

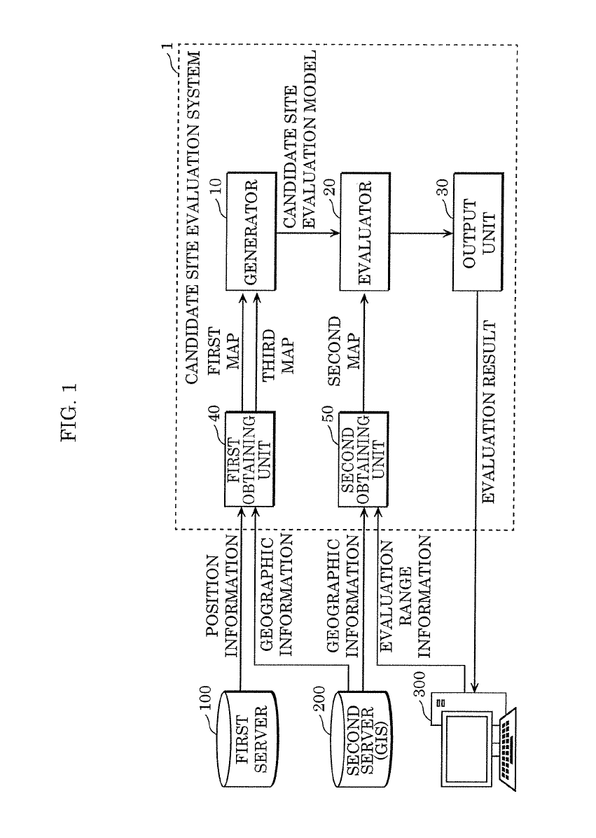

Hereinafter, an embodiment will be described with reference to FIGS. 1 to 12.

FIG. 1 is a configuration diagram illustrating an example of candidate site evaluation system 1 according to the embodiment. In FIG. 1, in addition to candidate site evaluation system 1, first server 100, second server 200, and terminal 300 that can communicate with candidate site evaluation system 1 are illustrated.

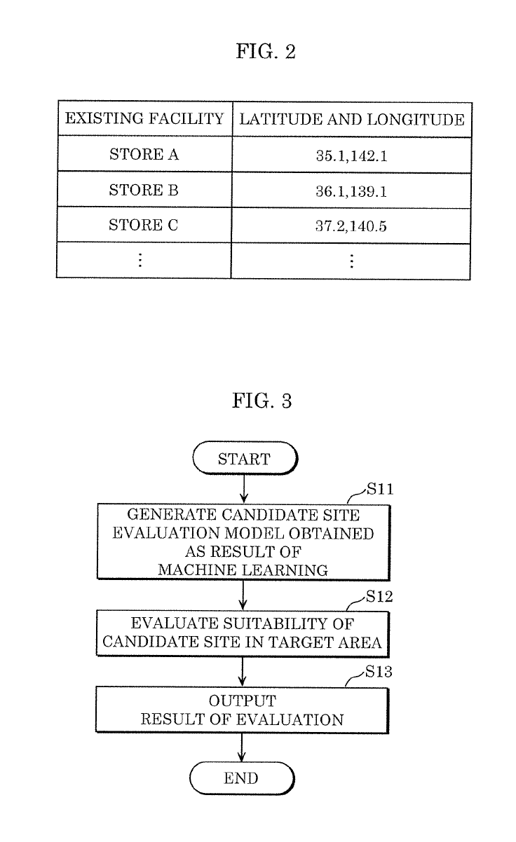

First server 100 is a computer that includes a processor (microprocessor), a memory, and a communication interface (such as a communication circuit). First server 100 stores position information that indicates the positions of existing facilities of predetermined business types. A device coupled to first server 100 via the Internet can obtain the position information from first server 100. The predetermined business types include retail business, education and learning supporting business, medical industry, service industry, and are not particularly limited. The position information is, for instance, the latitudes and longitudes of existing facilities. FIG. 2 is a table illustrating an example of the position information. FIG. 2 illustrates the latitude and longitude of each of existing retail stores as an example of existing facilities of predetermined business types. First server 100 can communicate with candidate site evaluation system 1, for instance, via a network such as the Internet, and candidate site evaluation system 1 obtains the position information from first server 100.

Second server 200 is a computer including a processor (microprocessor), a memory, and a communication interface (such as a communication circuit), and is, for instance, a geographical information system (GIS). A device coupled to second server 200 via the Internet can obtain geographic information from second server 200. The GIS is a technology that enables comprehensive management and processing of geographic information, and visual display of the geographic information. The geographic information includes information indicating the position of specific location or district in the space, and information on various phenomena related to the above information. For instance, the geographic information represents a situation of a specific theme such as a socioeconomic activity, and specifically, is an urban planning map, a topographical map, place name information, statistical information, aerial photography, and satellite imagery. Second server 200 can communicate with candidate site evaluation system 1, for instance, via a network such as the Internet, and candidate site evaluation system 1 obtains the geographic information from second server 200.

Terminal 300 is a computer including a processor (microprocessor), a memory, and a communication interface (such as a communication circuit), and a user interfaces (such as a display, a keyboard, and a touch panel), and, for instance, a mobile terminal such as a personal computer (PC), a smartphone, and a tablet. Terminal 300 can communicate with candidate site evaluation system 1, for instance, via a network such as the Internet. A user evaluates a candidate site by transmitting evaluation range information to candidate site evaluation system 1 using terminal 300 (causes candidate site evaluation system 1 to evaluate a candidate site). The evaluation range information will be described later.

Candidate site evaluation system 1 is a system for evaluating a candidate site for opening a facility. The facility refers to a store in retail business such as a convenience store, and a supermarket, a school, a hospital, a restaurant, an accommodation facility a store in the service industry, and a leisure facility, and is not particularly limited. Also, opening a store, opening a school, and establishing a hospital are collectively called opening a facility. Candidate site evaluation system 1 includes generator 10, evaluator 20, output unit 30, first obtaining unit 40, and second obtaining unit 50 as the functional components. Although not illustrated, candidate site evaluation system 1 includes a storage.

Candidate site evaluation system 1 is a computer including a processor (microprocessor), a memory (storage), and a communication interface (such as a communication circuit). Candidate site evaluation system 1 can be implemented by a server usable via a network such as the Internet, that is, so-called cloud server. The memory is a ROM, or a RAM, and can store control programs (computer programs) executed by the processor. For instance, the processor operates in accordance with a control program (computer program), and thus candidate site evaluation system 1 implements generator 10, evaluator 20, output unit 30, first obtaining unit 40, and second obtaining unit 50.

Although candidate site evaluation system 1 is implemented, for instance, by a single server, candidate site evaluation system 1 may be implemented by multiple servers. In this case, the functional components may be distributed over the multiple servers. As an example, generator 10, evaluator 20, and output unit 30 may be implemented by one of the multiple servers, and first obtaining unit 40 and second obtaining unit 50 may be implemented by another server. The arrangement of distribution of the functional components is not particularly limited to this.

First obtaining unit 40 obtains position information (latitude and longitude) from first server 100, and obtains geographic information from second server 200. First obtaining unit 40 specifically obtains a topographical map of any area as the geographic information from second server 200. The topographical map is a first map in which the topography of the any area is drawn on a plane with a reduced scale. The first map represents structural features of planar topography such as roads, railroads, rivers, and buildings in the any area, for instance. First obtaining unit 40 then plots the position information (the positions of the existing facilities in the any area) obtained from first server 100 on the first map, thereby obtaining the third map. Like this, in this embodiment, the position information is information to be shown on the third map in any area. For instance, first obtaining unit 40 obtains the latitude and longitude of each position in a topographical map from second server 200, thereby making it possible to plot the position of each of the existing facilities represented by the latitude and longitude on the topographical map (the first map). In this manner, first obtaining unit 40 prepares multiple paired images of the first map and the third map in the same area. Specifically, first obtaining unit 40 prepares paired images in different areas, such as first paired images of the first map and the third map in any area, second paired images of the first map and the third map in another area, and so on.

It should be noted that candidate site evaluation system 1 does not need to include first obtaining unit 40. For instance, a storage (not illustrated) included in candidate site evaluation system 1 may pre-store multiple paired images of the first map and the third map. Alternatively, candidate site evaluation system 1 may be a system that includes first server 100 and second server 200.

Second obtaining unit 50 obtains geographic information from second server 200, and obtains evaluation range information from terminal 300. The evaluation range information is information for specifying a target area for evaluation as a candidate site by a location (latitude and longitude) and a length from the location, for instance, “the area of a square of 300 m side at the center of the latitude and longitude {35.1, 142.0}”. For instance, a user inputs evaluation range information via a user interface (for instance, a keyboard) of terminal 300, the evaluation range information is thereby transmitted to candidate site evaluation system 1, and second obtaining unit 50 obtains a topographical map from second server 200, the topographical map indicating a target area corresponding to the received evaluation range information. The topographical map is a second map that shows a target area including a candidate site to be evaluated, and represents, for instance, structural features of planar topography such as roads, railroads, rivers, and buildings in the target area.

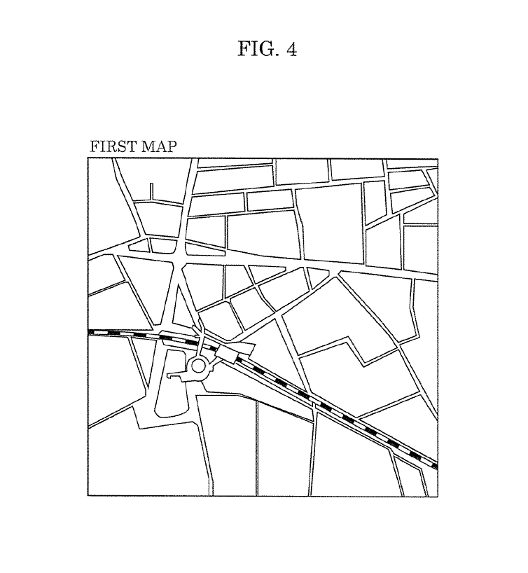

Next, generator 10, evaluator 20, and output unit 30 will be described with reference to FIG. 3 and other figures.

FIG. 3 is a flowchart illustrating an example of the operation of candidate site evaluation system 1 according to the embodiment.

First, generator 10 generates a candidate site evaluation model on which machine learning has been performed using the first map which shows any area, and position information indicating the positions of existing facilities of a predetermined business type in the any area, and which evaluates a candidate site for opening a facility of the predetermined business type (step S11). In this embodiment, generator 10 generates a candidate site evaluation model on which machine learning has been performed using the first map and the third map (position information). Generator 10 generates a candidate site evaluation model by Deep Learning as a technique of machine learning.

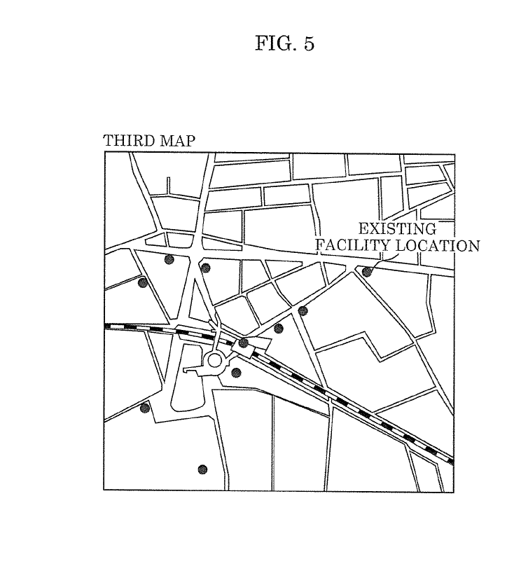

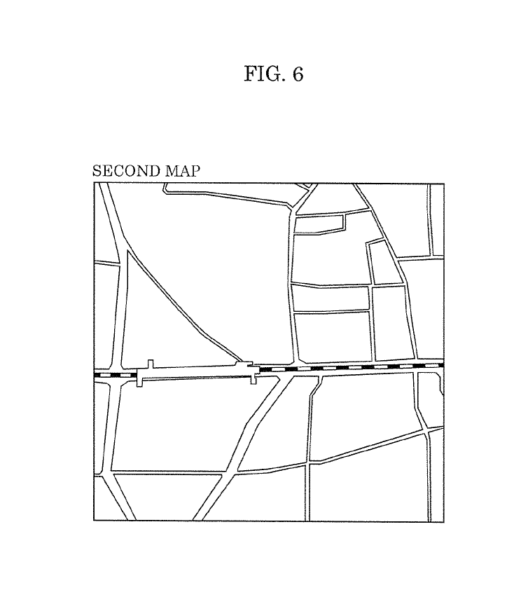

For instance, for various areas, generator 10 learns what kind of location tends to have more facilities of a predetermined business type using paired images of the first map in which the positions of existing facilities of a predetermined business type are not shown and the third map in which the positions of the existing facilities are shown. This will be described with reference to FIGS. 4 and 5.

FIG. 4 is a map illustrating an example of the first map. FIG. 5 is a map illustrating an example of the third map. The maps illustrated in FIGS. 4 and 5 are an example of paired images in the same area. The third map is a map such that the positions of the existing facilities are plotted on the first map, and provides teaching data to which so-called correct labels (the positions of the existing facilities) are attached. Generator 10 performs learning using paired images for various areas as illustrated in FIGS. 4 and 5, and learns that a facility of a predetermined business type tends to be located near a station, at a corner lot, or near a crossing, for instance. By using a candidate site evaluation model on which machine learning has been performed in this manner, candidate sites for a facility of a predetermined business type can be plotted on the map (for instance, the second map) of an unknown area. It should be noted that the technique of machine learning is not limited to Deep Learning, and other techniques may be used.

It should be noted that the machine learning may be performed using the first map and the position information (the positions of the existing facilities, for instance, the latitudes and longitudes). In other words, instead of the third map, the position information may be inputted to generator 10. In this case, machine learning is performed using a pair of the list of latitudes and longitudes as illustrated in FIG. 2 and the first map. It should be noted that no significant difference of generated candidate site evaluation models is observed between the case where machine learning is performed using the first map and the position information and the case where machine learning is performed using the first map and the third map. This is because the third map is information in which position information is added to the first map, and there is no significant difference between the information used in the both cases.

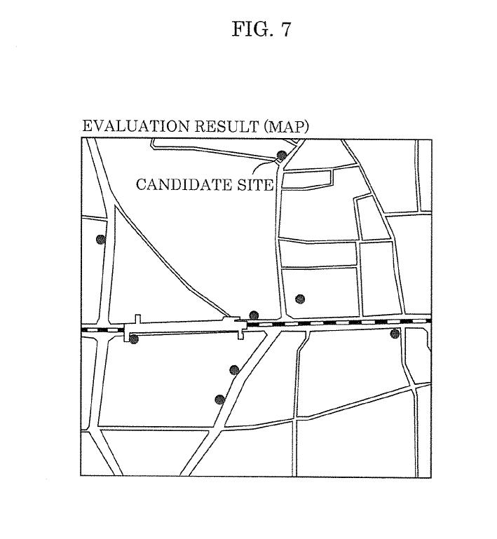

Subsequently, evaluator 20 evaluates the suitability of a candidate site in a target area based on the second map indicating the target area including a candidate site to be evaluated, and the candidate site evaluation model (step S12). FIG. 6 is a map illustrating an example of the second map, and indicates an unknown area as well as a target area, specified by a user, including a candidate site to be evaluated for instance, the target area being different from the area used for learning by generator 10. It should be noted that the area (target area) shown in the second map may include an area used for the learning so far.

Output unit 30 then outputs an evaluation result (step S13). Specifically, as an evaluation result, output unit 30 outputs a map showing candidate sites having suitability at a certain level of higher in the target area to terminal 300.

FIG. 7 is a map illustrating an example of the evaluation result. As illustrated in FIG. 7, the evaluation result includes the map showing candidate sites having suitability at a certain level of higher in the target area. The map is a map such that candidate sites for a facility of a predetermined business type are plotted on the second map, the candidate sites having suitability at a certain level of higher. Based on the result of learning in the candidate site evaluation model, evaluator 20 evaluates that locations near a station, at a corner lot, or near a crossing are excellent candidate sites as described above. The evaluation result (map) illustrated in FIG. 7 is displayed, for instance, on a user interface (for instance, a display) of terminal 300, and thus a user can select an excellent location for opening a facility.

As described above, the first map showing any area is a map in which the topography of a certain area is drawn on a plane with a reduced scale, and such a map has been widely distributed, and thus easily available. The position information indicating the positions of existing facilities of a predetermined business type is also easily available by searching using the Internet or the like. Since the easily available information is used in machine learning, a candidate site for opening a facility can be easily evaluated. Furthermore, these information are available with a low cost. Thus, a candidate site evaluation model can be generated with a low cost, and eventually, a candidate site evaluation system can be implemented with a low cost. Since a candidate site is evaluated by a candidate site evaluation model based on machine learning, the accuracy of evaluation of a candidate site can be increased, as compared with when a human makes subjective decisions and evaluates a candidate site. Specifically, a candidate site is mechanically evaluated, and thus candidate sites having high suitability can be outputted without fail, as compared with when a human makes subjective decisions.

In addition, machine learning is performed using paired images of the first map in which the positions of existing facilities are not shown in any area and the third map in which the positions of existing facilities are shown in the any area. Thus, the machine learning can be efficiently performed by comparing the maps.

In addition, the machine learning is performed using geographic information on land, facility, and road obtained from GIS, for instance. Thus, the information used for the machine learning is increased, the accuracy of the machine learning is increased, and the accuracy of evaluation of a candidate site can be increased.

Since the evaluated candidate sites are shown on a map, excellent candidate sites become visually quite obvious.

It should be noted that candidate site evaluation system 1 does not need to include generator 10 that generates a candidate site evaluation model. In this case, for instance, a storage (not illustrated) included in candidate site evaluation system 1 may pre-store a candidate site evaluation model generated not by candidate site evaluation system 1, and evaluator 20 may evaluate a candidate site by obtaining the candidate site evaluation model from the storage.

The first map and the second map include information on at least one of an amount of traffic, a congestion degree, a road classification, an altitude, a business type of facility, a facility name, and a land classification. These pieces of information can be obtained from GIS, for instance.

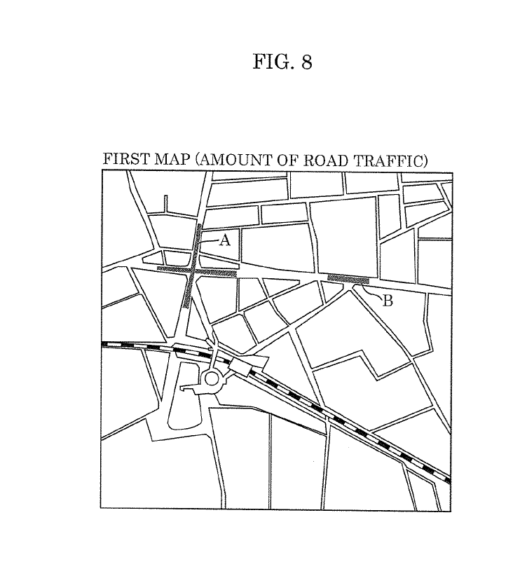

FIG. 8 is a map illustrating an example of information included in the first map. For instance, as illustrated in FIG. 8, the first map may include information indicating amounts of traffic of roads. For instance, a color (for instance, red) is applied to the locations indicated by A and B in FIG. 8 on the roads of the first map, and a darker color indicates a larger amount of traffic.

Machine learning can be performed in consideration of a relationship between the position of each existing facility of a predetermined business type and an amount of traffic by using paired images of the first map including information indicating the amounts of traffic of roads, and the third map which shows the position of each existing facility of a predetermined business type. A candidate site can be evaluated in consideration of a relationship between the amount of traffic of a road and the position of each existing facility of a predetermined business type by using the second map and a candidate site evaluation model which has learned about a relationship between the position of each existing facility of a predetermined business type and the amount of traffic of a road, the second map including information indicating the amounts of traffic of roads. For instance, it is possible to learn that a facility of a predetermined business type tends to be located near a road having a large amount of traffic, and to evaluate a candidate site in consideration of the position which has a large amount of traffic and is expected to attract more customers.

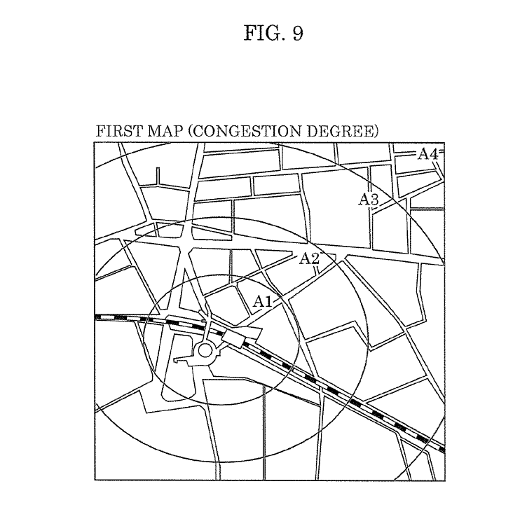

FIG. 9 is a map illustrating another example of information included in the first map. For instance, as illustrated in FIG. 9, the first map may include information indicating a congestion degree of people. For instance, the areas indicated by A1 to A4 in FIG. 9 are individually colored according to a congestion degree of people (for instance, colored in blue for low congestion, yellow for medium congestion, and red for high congestion), and the congestion degree increases in the order of A4, A3, A2, and A1.

Machine learning can be performed in consideration of a relationship between the position of each existing facility of a predetermined business type and a congestion degree of people by using paired images of the first map including information indicating congestion degrees, and the third map which shows the position of each existing facility of a predetermined business type. A candidate site can be evaluated in consideration of a relationship between a congestion degree of people and the position of each existing facility of a predetermined business type by using the second map and a candidate site evaluation model which has learned about a relationship between the position of each existing facility of a predetermined business type and a congestion degree of people, the second map including information indicating congestion degrees of people. For instance, it is possible to learn that a facility of a predetermined business type tends to be located near an area with a higher congestion degree, and to evaluate a candidate site in consideration of the position which has a higher congestion degree and is expected to attract more customers.

Also, the first map may include information indicating road classifications such as one-way traffic. Machine learning can be performed in consideration of a relationship between the position of each existing facility of a predetermined business type and a road classification such as one-way traffic by using paired images of the first map including information indicating road classifications, and the third map which shows the position of each existing facility of a predetermined business type. A candidate site can be evaluated in consideration of a relationship between a road classification and the position of each existing facility of a predetermined business type by using the second map and a candidate site evaluation model which has learned about a relationship between the position of each existing facility of a predetermined business type and a road classification, the second map including information indicating road classifications. For instance, it is possible to learn that a facility of a predetermined business type tends to be located near a road having a road classifications of one-way traffic, and to evaluate a candidate site in consideration of the position which is near a one-way traffic road and expected to attract more customers.

The first map may include information indicating altitudes. Machine learning can be performed in consideration of a relationship between the position of each existing facility of a predetermined business type and an altitude by using paired images of the first map including information indicating altitudes, and the third map which shows the position of each existing facility of a predetermined business type. A candidate site can be evaluated in consideration of a relationship between an altitude and the position of each existing facility of a predetermined business type by using the second map and a candidate site evaluation model which has learned about a relationship between the position of each existing facility of a predetermined business type and an altitude, the second map including information indicating altitudes. For instance, it is possible to learn that a facility of a predetermined business type is unlikely to be located at a position with a high altitude (for instance, the top of an uphill road), and to evaluate a candidate site in consideration of the position which has a high altitude and prevents customers from coming.

The first map may include information indicating business types of facility and facility names. Machine learning can be performed in consideration of a relationship between the position of each existing facility of a predetermined business type and a business type of facility, a facility name by using paired images of the first map including information indicating business types of facility and facility names, and the third map which shows the position of each existing facility of a predetermined business type. A candidate site can be evaluated in consideration of a relationship between a business type of facility, a facility name and the position of each existing facility of a predetermined business type by using the second map and a candidate site evaluation model which has learned about a relationship between the position of each existing facility of a predetermined business type and a business type of facility, a facility name, the second map including information indicating business types of facility and facility names. For instance, it is possible to learn that a facility of a predetermined business type should not be opened near another facility of the same business type, and to evaluate a candidate site in consideration of the position of a competing facility, which prevents customers from coming. For instance, it is possible to learn that a facility of a predetermined business type tends to be located near a station, a leisure facility, and a facility of a business type different from the predetermined business type, and to evaluate a candidate site in consideration of the position of a facility of a different business type, which is expected to attract more customers.

The first map may include information indicating land classifications. Machine learning can be performed in consideration of a relationship between the position of each existing facility of a predetermined business type and a land classification by using paired images of the first map including information indicating land classifications, and the third map which shows the position of each existing facility of a predetermined business type. A candidate site can be evaluated in consideration of a relationship between a land classification and the position of each existing facility of a predetermined business type by using the second map and a candidate site evaluation model which has learned about a relationship between the position of each existing facility of a predetermined business type and a land classification, the second map including information indicating land classifications. For instance, it is possible to learn that a facility of a predetermined business type is unlikely to be located at a position near a river where no bridge crossing the river is provided nearby, and to evaluate a candidate site in consideration of the position of a physical block such as a river, which prevents customers from coming.

In addition, the first map and the second map may include traffic line information on pedestrian, bicycle, and automobile, timetables and statistical information (such as stop frequency of buses, trains) on transportation systems, attribute information (such as articles handled in facilities) on facilities, or statistical data (such as the size of a parking space in the surroundings of facilities) related to the surroundings of facilities.

As described above, the first map and the second map include information on at least one of an amount of traffic, a congestion degree, a road classification, an altitude, a business type of facility, a facility name, and a land classification, and thus the machine learning is performed in consideration of factors to prevent customers from coming to a facility and factors to attract customers to a facility. Consequently, the accuracy of evaluation of a candidate site can be increased.

The first map and the second map may be aerial photography. Thus, whether each residence is an independent house or an apartment can be determined, and it is possible to learn that a facility of a predetermined business type tends to be located near an apartment, and to evaluate a candidate site in consideration of the position which is near an apartment and expected to attract more customers.

It should be noted that the first map and the second map may each include multiple maps. In this case, the information on at least one of an amount of traffic, a congestion degree, a road classification, an altitude, a business type of facility, a facility name, and a land classification may be distributed and included in the multiple maps. Specifically, for instance, the first map and the second map may include multiple maps such as a map in which structural features of planar topography are shown, a map in which amounts of traffic are shown, a map in which congestion degrees are shown, and so on. All the above-mentioned information does not need to be included in a single map. Since the above-mentioned information is distributed over the multiple maps in this manner, pieces of information are unlikely to be lost at the same location during machine learning, thus the accuracy of machine learning is increased, and the accuracy of evaluation of the suitability can be improved.

Although output unit 30 outputs a map showing candidate sites having suitability at a certain level of higher in the target area as an evaluation result, the evaluation result to be outputted is not limited to this.

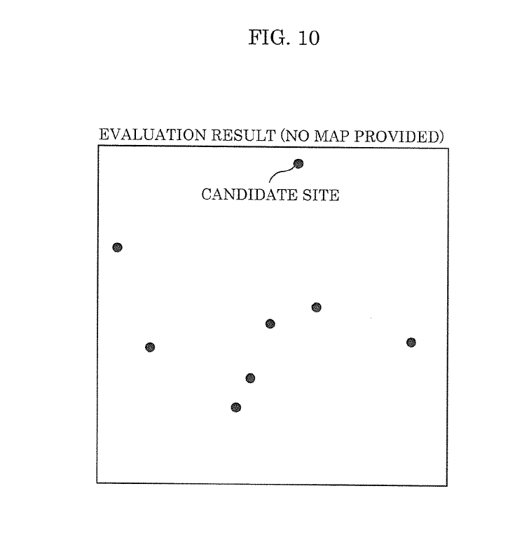

FIGS. 10 to 12 are each a map illustrating another example of the evaluation result.

For instance, as illustrated in FIG. 10, output unit 30 may output a map showing only the candidate sites having suitability at a certain level of higher as an evaluation result. Consequently, it is possible for a user to superimpose and display the candidate sites on information desired by the user other than the second map at terminal 300.

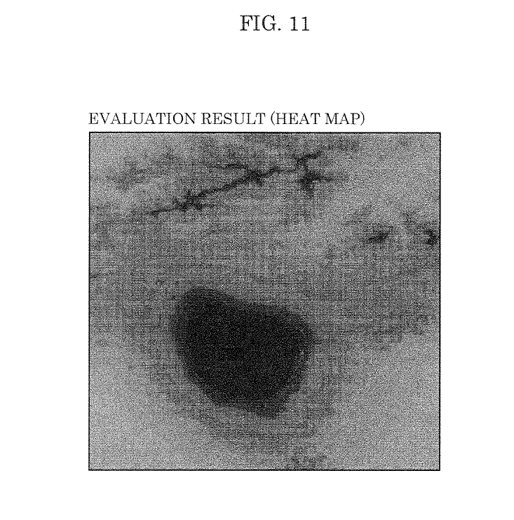

For instance, as illustrated in FIG. 11, output unit 30 may output a heat map as an evaluation result, the heat map showing suitability for each location in the target area. In FIG. 11, a higher density of dots (a darker black color) indicates higher suitability. When the candidate sites having suitability at a certain level of higher are discretely shown by points as in FIG. 7, a candidate site may not be used because the site is the property of others, and the suitability of a location slightly away from the site may be desired to be obtained. As illustrated in FIG. 11, suitability is displayed on the entire map of the heat map, thus excellent candidate sites can be widely and effectively shown. Therefore, promising candidate sites can be comprehensively grasped.

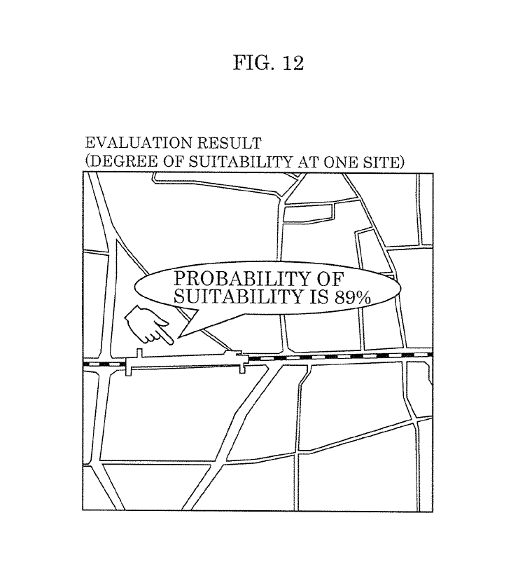

For instance, as illustrated in FIG. 12, output unit 30 may output suitability of one location in the target area as an evaluation result. When the one location is indicated by the fingertip of the hand icon illustrated in FIG. 12, suitability (probability of suitability) of the one location is outputted as the evaluation result. The one location corresponds, for instance, to one pixel in the map image, and the probability of suitability can be outputted pixel by pixel. The suitability may not be outputted in percentage as illustrated in FIG. 12, and may be outputted as A rank, B rank, and so on, for instance. When such an evaluation result is outputted, for instance, some lands may be already on sale, and the evaluation result is effective when the suitability of the lands is desired to be obtained. In this manner, it is possible to designate a specific location to check the suitability of the location in detail as the candidate site. In particular, when there is a land of interest, degree of suitability of the land can be directly obtained.

For instance, machine learning may be performed using paired images of the first map and the third map in an area where no existing facility of a predetermined business type is present, as the any area. In this case, the locations, at which a facility of a predetermined business type is unlikely to be located, can be actively learned, thus it is possible to avoid opening a facility at an unfavorable location.

Also, the existing facilities may include a facility which existed in the past but does not exist at present in the any area. The position of the facility is such that after the facility is opened, a competing store is opened in the neighborhood, a facility in the neighborhood, which has attracted many customers (for instance, a gas station), has closed, or a store has closed due to factors such as decrease in the population in the neighborhood or insufficient number of employed part-timers. The position information may include such negative examples which are not suitable for opening a facility. Consequently, the positions of the facilities which have closed can be learned, and opening a facility at an unfavorable location can be avoided.

### Other Embodiments

Although candidate site evaluation system 1 of the present disclosure has been described so far based on the embodiment, the present disclosure is not limited to the embodiment. As long as not departing from the essence of the present disclosure, an embodiment obtained by making various changes, which occur to those skilled in the art, to the present embodiment, and an embodiment obtained by combining the components of different embodiments are also included in the scope of the present disclosure.

For instance, the present disclosure can be implemented not only as candidate site evaluation system 1, but also as a method that includes the steps (processing) to be performed by the components included in candidate site evaluation system 1.

Specifically, as illustrated in FIG. 3, a candidate site evaluation method uses a computer to generate a candidate site evaluation model on which machine learning has been performed using the first map which shows any area, and position information indicating the positions of existing facilities of a predetermined business type in the any area, and which evaluates a candidate site for opening a facility of the predetermined business type (step S11). The suitability of a candidate site in a target area is evaluated based on the second map indicating the target area including the candidate site to be evaluated, and the candidate site evaluation model (step S12), and an evaluation result is outputted (step S13).

For instance, those steps may be performed by a computer (computer system). The present disclosure can be implemented as a program that causes a computer to execute the steps included in those methods. Furthermore, the present disclosure can be implemented as a non-transitory computer readable recording medium, such as a CD-ROM, on which a program is recorded.

For instance, when the present disclosure is implemented by a program (software), the program is executed by utilizing hardware resources such as a CPU, a memory, and an I/O circuit of the computer, thereby performing the steps. Specifically, the steps are performed by the CPU obtaining data from a memory or an I/O circuit and calculating the data, and outputting a calculation result to the memory or the I/O circuit.

Also, the multiple components included in candidate site evaluation system 1 in the embodiment may be each implemented as a dedicated circuit or a general-purpose circuit. These components may be implemented as a single circuit or implemented as multiple circuits.

Also, the multiple components included in candidate site evaluation system 1 in the embodiment may be implemented as a large scale integration (LSI) which is an integrated circuit (IC). These components may be individually implemented as a single chip, or a single chip may include part or all of the components. The LSI may be called a system LSI, a super LSI, or an ultra LSI depending on the degree of integration.

The integrated circuit is not limited to an LSI, and may be implemented as a dedicated circuit or a general-purpose processor. Also, a field programmable gate array (FPGA) which can be programmed, or a reconfigurable processor, by which connection and setting of the circuit cells inside the LSI can be reconfigured, may be utilized.

Furthermore, in the case where new technology of circuit integration which replaces the LSI is created due to the progress of semiconductor technology or other emerging technology, naturally, the components included in candidate site evaluation system 1 may be integrated using the technology.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

An aspect of the present disclosure is applicable, for instance, to a service for selecting an excellent location for opening a facility (such as opening a store) in an extensive area.

What is claimed is:

1. A candidate site evaluation system, comprising:
an evaluator that evaluates suitability of a candidate site in a target area based on a candidate site evaluation model and a second map, the candidate site evaluation model being obtained as a result of machine learning using a first map that shows any area and position information indicating locations of one or more existing facilities of a predetermined business type in the any area and being for evaluating the candidate site for opening a facility of the predetermined business type, the second map showing the target area including the candidate site to be evaluated; and
an output unit that outputs a result of the evaluation.

2. The candidate site evaluation system according to claim 1, further comprising
a generator that generates the candidate site evaluation model.

3. The candidate site evaluation system according to claim 1,
wherein the position information is shown on a third map in the any area.

4. The candidate site evaluation system according to claim 1,
wherein the first map and the second map include geographic information obtained from a Geographic Information System (GIS).

5. The candidate site evaluation system according to claim 1,
wherein the first map and the second map include information on at least one of an amount of traffic, a congestion degree, a road classification, an altitude, a business type of facility, a facility name, and a land classification.

6. The candidate site evaluation system according to claim 1,
wherein the output unit outputs a map as the evaluation result, the map showing a candidate site having suitability at a certain level or higher in the target area.

7. The candidate site evaluation system according to claim 1,
wherein the output unit outputs a heat map as the evaluation result, the heat map showing suitability of each of the locations in the target area.

8. The candidate site evaluation system according to claim 1,
wherein the output unit outputs suitability of one location in the target area as the evaluation result.

9. The candidate site evaluation system according to claim 1,
wherein the one or more existing facilities include a facility which existed in past but does not exist at present in the any area.

10. A candidate site evaluation method performed using a computer, the method comprising:
generating a candidate site evaluation model which is obtained as a result of machine learning using a first map that shows any area and position information indicating locations of one or more existing facilities of a predetermined business type in the any area, and which is for evaluating a candidate site for opening a facility of the predetermined business type;
evaluating suitability of the candidate site in a target area based on a second map and the candidate site evaluation model, the second map showing the target area including the candidate site to be evaluated; and
outputting a result of the evaluating.
